(19) United States
(12) Patent Application Publication
(10) Pub. No.: US 2024/0429829 A1
(43) Pub. Date: Dec. 26, 2024

(54) DUAL ACTIVE BRIDGE CONVERTER, METHOD AND APPARATUS OF CONTROLLING DUAL ACTIVE BRIDGE CONVERTER, ELECTRONIC DEVICE, STORAGE MEDIUM, AND PROGRAM

(71) Applicant: Murata Manufacturing Co., Ltd., Nagaokakyo-shi (JP)

(72) Inventors: Xiaohuan YU, Wuhan (CN); Long NING, Wuhan (CN); Xiaolei ZHANG, Wuhan (CN)

(21) Appl. No.: 18/744,787

(22) Filed: Jun. 17, 2024

(30) Foreign Application Priority Data
Jun. 21, 2023 (CN) 202310744773.X

(51) Int. Cl. H02M 3/335; H02M 1/00; H02M 1/08

(52) U.S. Cl. CPC H02M 3/33573; H02M 1/0022; H02M 1/083; H02M 3/33592

(57) ABSTRACT

A dual active bridge converter includes a first full-bridge circuit and a high-frequency inductor. The first full-bridge circuit includes a first bridge arm including a first switching element and a second switching element connected in series. Methods of controlling a dual active bridge converter include detecting a voltage of the high-frequency inductor in response to the first switching element being turned off, setting a dead time according to a detection result of the detecting the voltage of the high-frequency inductor, and turning on the second switching element based on the dead time.

### CROSS REFERENCE TO RELATED APPLICATIONS

This application claims priority to Chinese Patent Application No. 202310744773.X, filed on Jun. 21, 2023 and entitled “DUAL ACTIVE BRIDGE CONVERTER, METHOD AND APPARATUS OF CONTROLLING DUAL ACTIVE BRIDGE CONVERTER, ELECTRONIC DEVICE, STORAGE MEDIUM, AND PROGRAM”, the entire contents of which are incorporated herein in its entirety by reference.

### BACKGROUND OF THE INVENTION

### 1. Field of the Invention

The present disclosure relates to dual active bridge converters, methods and apparatuses of controlling a dual active bridge converter, electronic devices, storage mediums, and programs.

### 2. Description of the Related Art

An existing dual active bridge (DAB) DC-DC converter is also called a dual active bridge converter or a DAB converter. A circuit topology of the DAB converter includes a primary side full-bridge circuit and a secondary side full-bridge circuit, each including four switching elements. A magnetic network composed of a high-frequency inductor and a high-frequency transformer is connected to AC ports of the primary side full-bridge circuit and the secondary side full-bridge circuit.

The DAB converter may achieve an electrical isolation between an input and an output, may have a bidirectional power processing capability, and may have advantages such as high power density and easy implementation of soft switching. Therefore, the DAB converter is widely used in various application scenarios that need DC power supply systems.

In an existing structure of the DAB converter, for each bridge arm, an upper switching element and a lower switching element of the bridge arm are turned on in a complementary manner. Therefore, a dead time should be reserved to avoid a pass-through phenomenon. The dead time is related to a parasitic parameter of a MOS (field-effect transistor) model. Different models have different parasitic parameters, and different turn-on time lengths and turn-off time lengths. Thus, an appropriate dead time may be determined in a system.

In existing designs, in order to avoid the pass-through phenomenon of the bridge arm, the worst-case scenario can be considered. Therefore, the dead time will be sufficiently reserved to meet the needs of MOS transistors from different manufacturers. However, for a same bridge arm, when an upper transistor of the bridge arm is turned off and a lower transistor of the bridge arm is not turned on, or when the lower transistor is turned off and the upper transistor is not turned on, a current may flow through the body diode of the switching element, and excessive dead time will cause excessive losses.

In addition, an existing method of setting the dead time is to measure by using an oscilloscope, and add an appropriate margin to a measurement result, so as to set a fixed dead time. In order to obtain an appropriate dead time, multiple checks are needed, and it is not easy to obtain designed margin information. The setting process is relatively complicated.

### SUMMARY OF THE INVENTION

Example embodiments of the present invention provide dual active bridge converters, methods and apparatuses of controlling dual active bridge converters, electronic devices, storage mediums, and programs.

According to an example embodiment of the present disclosure, a method of controlling a dual active bridge converter is provided. The dual active bridge converter includes a first full-bridge circuit and a high-frequency inductor, the first full-bridge circuit includes a first bridge arm, the first bridge arm includes a first switching element and a second switching element connected in series, and the method includes: detecting a voltage of the high-frequency inductor in response to the first switching element being turned off; setting a dead time according to a detection result of the detecting the voltage of the high-frequency inductor; and turning on the second switching element based on the dead time.

Further, according to an example embodiment of the present disclosure, detecting the voltage of the high-frequency inductor includes: detecting, by using a sampling circuit including an inductor coupled with the high-frequency inductor, an induced voltage generated on the inductor as the voltage of the high-frequency inductor.

Further, according to an example embodiment of the present disclosure, setting the dead time according to the detection result of the detecting the voltage of the high-frequency inductor includes: setting the dead time in response to a rising edge or a falling edge of the voltage of the high-frequency inductor being detected.

Further, according to an example embodiment of the present disclosure, setting the dead time according to the detection result of the detecting the voltage of the high-frequency inductor includes: calculating a time difference between a time instant at which the first switching element is turned off and a time instant at which a rising edge or a falling edge of the voltage of the high-frequency inductor is detected in response to the rising edge or the falling edge of the voltage of the high-frequency inductor being detected, and determining the time difference as the dead time.

Further, according to an example embodiment of the t disclosure, setting the dead time according to the present detection result of the detecting the voltage of the high-frequency inductor further includes: determining whether the time difference is less than a default dead time; and setting the time difference as the dead time in a case that the time difference is less than the default dead time.

Further, according to an example embodiment of the present disclosure, the method further includes: transmitting a turn-on control signal to the second switching element according to the detection result of the detecting the voltage of the high-frequency inductor.

Further, according to an example embodiment of the present disclosure, the first full-bridge circuit further includes a second bridge arm connected in parallel with the first bridge arm, and the method further includes: turning on a switching element of the second bridge arm after the dead time, after another switching element of the second bridge arm is turned off.

Further, according to an example embodiment of the present disclosure, the dual active bridge converter further includes a second full-bridge circuit, and the method further includes: turning on a switching element of a bridge arm of the second full-bridge circuit after the dead time, after another switching element of the bridge arm of the second full-bridge circuit is turned off.

Further, according to an example embodiment of the present disclosure, in a case that an operating mode of the dual active bridge converter is a buck mode, the first full-bridge circuit is a primary side full-bridge circuit, and the first bridge arm is a leading arm; and in a case that the operating mode of the dual active bridge converter is a boost mode, the first full-bridge circuit is a secondary side full-bridge circuit, and the first bridge arm is a leading arm.

According to an example embodiment of the present disclosure, a dual active bridge converter is provided, including a first full-bridge circuit, a second full-bridge circuit, a high-frequency transformer, and a high-frequency inductor, where the dual active bridge converter further includes a sampling circuit, the sampling circuit includes an inductor coupled with the high-frequency inductor, and the inductor is configured to couple with the high-frequency inductor to generate an induced voltage.

Further, according to an example embodiment of the present disclosure, the sampling circuit further includes a resistor connected in parallel with the inductor.

According to an example embodiment of the present disclosure, an apparatus of controlling a dual active bridge converter is provided, where the dual active bridge converter includes a first full-bridge circuit and a high-frequency inductor, the first full-bridge circuit includes a first bridge arm, the first bridge arm includes a first switching element and a second switching element connected in series, and the apparatus includes: a detector to detect a voltage of the high-frequency inductor in response to the first switching element being turned off; a setter to set a dead time according to a detection result of the detecting the voltage of the high-frequency inductor; and a controller configured or programmed to turn on the second switching element based on the dead time.

According to an example embodiment of the present disclosure, an electronic device is provided, including: at least one processor; and a memory communicatively connected to the at least one processor, where the memory stores instructions executable by the at least one processor, and the instructions, when executed by the at least one processor, cause the at least one processor to perform a method of an example embodiment of the present disclosure.

According to an example embodiment of the present disclosure, a non-volatile computer-readable storage medium including computer instructions therein is provided, where the computer instructions are configured to cause a computer to perform a method according to an example embodiment of the present disclosure.

The above and other elements, features, steps, characteristics, and advantages of the present invention will become more apparent from the following detailed description of the example embodiments with reference to the attached drawings.

### BRIEF DESCRIPTION OF THE DRAWINGS

FIG. 1 is a schematic diagram illustrating a circuit topology of a dual active bridge converter according to example embodiments of the present invention.

FIG. 2 is a schematic diagram illustrating a main flow chart of a method of controlling a dual active bridge converter according to example embodiments of the present invention.

FIG. 3 is a schematic timing diagram illustrating a voltage waveform in a method of controlling a dual active bridge converter according to example embodiments of the present invention.

FIG. 4 is a schematic waveform diagram for illustrating an effect of setting the dead time in a method of controlling a dual active bridge converter according to example embodiments of the present invention.

FIG. 5 is a schematic waveform diagram for illustrating an effect of setting a dead time in a method of controlling a dual active bridge converter in a comparative example.

### DETAILED DESCRIPTION OF THE EXAMPLE EMBODIMENTS

The present disclosure is further explained in detail below in conjunction with accompanying drawings and example embodiments. It can be understood that specific example embodiments described herein are only intended to explain the relevant disclosure, instead of limiting the present disclosure. In addition, it should be noted that for ease of description, only parts related to the relevant disclosure are shown in the accompanying drawings. In addition, the same elements are labeled with the same symbols and redundant explanations are omitted, as well as redundant explanations are omitted for elements with the same or corresponding functions and structures.

Example embodiments of the present disclosure are illustrated in detail with reference to the accompanying drawings.

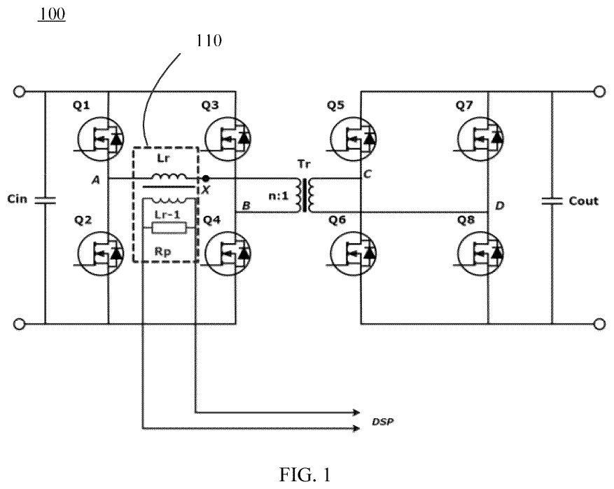

FIG. 1 is a schematic diagram illustrating a circuit topology of a dual active bridge converter according to example embodiments of the present disclosure.

As shown in FIG. 1, the dual active bridge converter 100 of example embodiments includes a primary side full-bridge circuit, a secondary side full-bridge circuit, a high-frequency transformer Tr, and a high-frequency inductor Lr. The primary side full-bridge circuit includes a switching element Q1, a switching element Q2, a switching element Q3, and a switching element Q4. The switching element Q1 and the switching element Q2 are connected in series to form a bridge arm, i.e., a leading arm. The switching element Q3 and the switching element Q4 are connected in series to form another bridge arm, i.e., a lagging arm. In the primary side full-bridge circuit, the two bridge arms are connected in parallel. The primary side full-bridge circuit can also include an input capacitor Cin connected in parallel with input terminals and connected in parallel with the two bridge arms. Similarly, the secondary side full-bridge circuit includes a switching element Q5, a switching element Q6, a switching element Q7, and a switching element Q8. The switching element Q5 and the switching element Q6 are connected in series to form a bridge arm, i.e., a leading arm. The switching element Q7 and the switching element Q8 are connected in series to form another bridge arm, i.e., a lagging arm. In the secondary side full-bridge circuit, the two bridge arms are connected in parallel. The secondary side full-bridge circuit can also include an output capacitor Cout connected in parallel with output terminals and connected in parallel with the two bridge arms.

In the dual active bridge converter 100 of example embodiments, a magnetic network composed of the high-frequency inductor Lr and the high-frequency transformer Tr is connected to AC ports of the primary side full-bridge circuit and the secondary side full-bridge circuit. The high-frequency transformer Tr achieves a current isolation between the primary side full-bridge circuit and the secondary side full-bridge circuit. The high-frequency inductor Lr can be an independent high-frequency inductor. A turns ratio of the high-frequency transformer Tr is n:1.

The dual active bridge converter 100 of example embodiments further includes a sampling circuit 110 as shown in the dashed box in FIG. 1. The sampling circuit 110 includes an inductor Lr-1 coupled with the high-frequency inductor Lr. The inductor Lr-1 is used to couple with the high-frequency inductor Lr to generate an induced voltage. The sampling circuit 110 may further include a resistor Rp connected in parallel with the inductor Lr-1. With the resistor Rp, the circuit may be protected, and this may avoid a high voltage caused by an open circuit on the secondary side of the coupling inductor Lr-1 which may damage the control circuit.

In example embodiments, there is no specific limitation on the types of the switching element Q1, the switching element Q2, the switching element Q3, the switching element Q4, the switching element Q5, the switching element Q6, the switching element Q7, and the switching element Q8. Bipolar transistors or unipolar transistors, such as MOSFETs (Metal-Oxide-Semiconductor Field-Effect Transistors), may be used. In example embodiments below, MOSFET, also abbreviated as “MOS transistor”, will be used as an example for explanation purposes.

In the topology of the dual active bridge converter, a high-frequency inductor Lr is connected to a middle point of the bridge arm. Therefore, by controlling a direction of the inductor current reasonably, zero voltage switching (ZVS) of all switching elements may be achieved, thereby reducing switching losses of the dual active bridge converter 100. A basic principle of achieving ZVS of a switching element is that an anti-parallel diode of the switching element is turned on before turning on a corresponding gate signal, and a voltage between a drain and a source of the switching element is reduced to zero. It should be noted that when the diode is turned on and before the gate signal is turned on, the current passing through the diode will cause significant losses. Thus, the dead time may be set reasonably. The inventors of the present disclosure have discovered from the operation principles of the dual active bridge converter 100 that the direction of the current will change after any MOS transistor is turned off. This may be used to optimize the time length for the current to pass through the diode. For the dual active bridge converter 100, the dead time refers to a time period in which it is not possible to turn on an upper MOS transistor and a lower MOS transistor of a same bridge arm simultaneously. In the dual active bridge converter 100, the upper MOS transistor and the lower MOS transistor are turned on in a complementary manner, ideally each accounting for 50% of a cycle. In practice, turning on MOS transistors takes a certain amount of time, and thus a dead time is desired to be set for the upper MOS transistor and the lower MOS transistor, so as to prevent a pass-through of the upper MOS transistor and the lower MOS transistor. The dead time cannot be too long. If the dead time is too long, the upper MOS transistor is completely turned off while the lower MOS transistor is not yet turned on, causing the current to flow through the body diode of the MOS transistor. A conduction voltage drop of the body diode is much greater than a conduction Rds_on voltage drop of the MOS transistor. If a current flows through the body diode, the power consumption will be increased. Therefore, in order to reduce the power consumption, the dead time is desired to be reduced. Generally, the dead time is set by measuring with an oscilloscope, but due to the different parasitic parameters of different MOS transistors, different turn-on time lengths and different turn-off time lengths of different MOS transistors may be used. The dead time may be reserved sufficiently to meet all needs of MOS transistors from different manufacturers. As a result, the reserved dead time may negatively affect the efficiency of the converter, and the setting process is relatively complicated.

The inventors of the present disclosure have found that in the dual active bridge converter 100, the alternate switching of any bridge arm will cause a voltage change on the high-frequency inductor Lr. Example embodiments of the present disclosure are implemented by utilizing this phenomenon.

In example embodiments, a method of controlling a dual active bridge converter is provided.

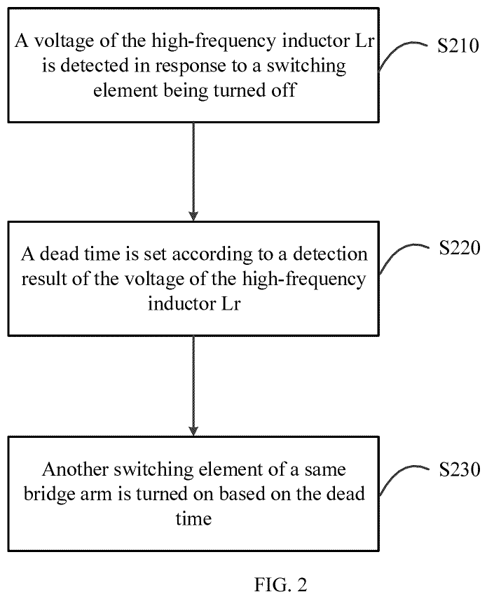

FIG. 2 is a schematic diagram illustrating a main flow chart of a method of controlling a dual active bridge converter according to example embodiments of the present disclosure.

As shown in FIG. 2, the method of controlling a dual active bridge converter of example embodiments includes steps S210, S220, and S230. In step S210, a voltage of the high-frequency inductor Lr is detected in response to a switching element included in a bridge arm of a full-bridge circuit being turned off. In step S220, a dead time is set according to a detection result of the detecting the voltage of the high-frequency inductor Lr. In step S230, another switching element of the same bridge arm is turned on based on the set dead time.

In example embodiments, when the upper MOS transistor and the lower MOS transistor of the bridge arm are switched to be turned on, a direction of the inductor current of the high-frequency inductor Lr will be changed. If the direction of the inductor current of the high-frequency inductor Lr is changed, a voltage will be generated due to the change in current of the high-frequency inductor Lr. For example, when the upper MOS transistor of the bridge arm is turned off and the lower MOS transistor of the bridge arm is about to be turned on, a voltage signal is obtained by detecting the voltage of the high-frequency inductor Lr. The voltage signal is sampled and processed by a digital signal processor (DSP) or microcontroller unit (MCU), etc., which may cause the lower MOS transistor to be turned on at an appropriate time instant.

It should s be noted that in example embodiments, the sampling circuit 110 shown in FIG. 1 can be used to detect the voltage of the high-frequency inductor Lr. By coupling the inductor Lr-1 included in the sampling circuit 110 with the high-frequency inductor Lr, an induced voltage is generated. The induced voltage generated on the inductor Lr-1 is detected as the voltage of the high-frequency inductor Lr. Based on this, it is convenient to detect the voltage of the high-frequency inductor Lr.

As a specific example of the implementation method of the sampling circuit 110, for example, the high-frequency inductor Lr may be connected in series with a coil winding, and the induced voltage may be generated by coupling the coil winding to define the sampling circuit 110. In addition, other isolation voltage samplers may also be used to sample the voltage of the high-frequency inductor Lr.

Next, an impact of switching actions of the 8 switching elements in the DAB converter 100 on the voltage of the high-frequency inductor Lr is illustrated in detail.

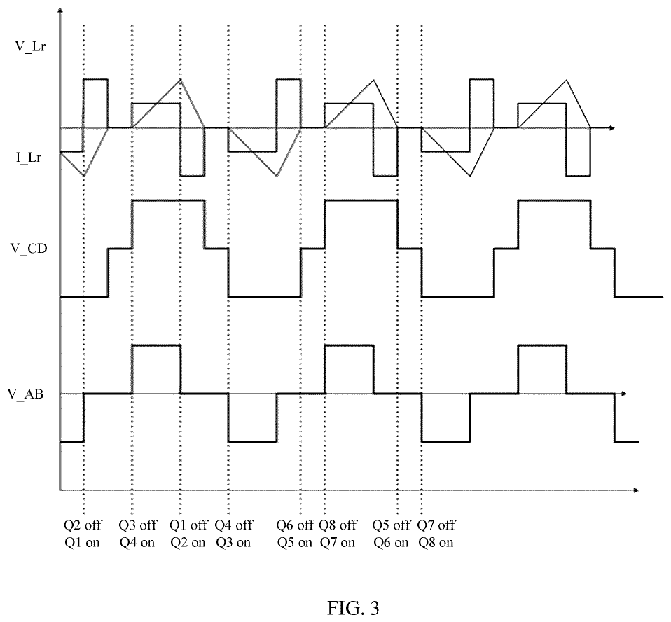

FIG. 3 is a schematic timing diagram illustrating a voltage waveform in a method of controlling a dual active bridge converter 100 according to example embodiments of the present disclosure.

As shown in FIG. 3, V_AB represents a primary side voltage of the transformer Tr, V_CD represents a secondary side voltage of the transformer Tr, V_Lr represents a voltage of the high-frequency inductor Lr, and I_Lr represents a current flowing through the high-frequency inductor Lr.

In the DAB converter 100, as shown in FIG. 1, the relationship of V_AB, V_CD, and V_AX satisfies the following equation 1, where V_AX is the voltage V_Lr of the high-frequency inductor Lr.

### Equation 1:

$$V\_AB - n * V\_CD = V\_AX = Lr * \frac{di}{dt} \qquad Equation 1$$

where n represents a turns ratio of the transformer, Lr represents an inductance value of the high-frequency inductor, and di/dt represents a rate of change of current over time.

Considering a buck mode as an example, the impact of the switching actions of the 8 switching elements in the DAB converter 100 on the voltage of the high-frequency inductor Lr is analyzed. It should be noted that for the convenience of explanation, the turns ratio n of the transformer is set to 1.

As shown in FIG. 3, in the buck mode, when the switching element Q2 is turned off and the switching element Q1 is turned on, the secondary side voltage V_CD of the transformer Tr is a negative output voltage Vout, and the primary side voltage V_AB of the transformer Tr changes from a negative input voltage Vin to zero. Therefore, a change amplitude of the voltage V_Lr on the high-frequency inductor Lr is −Vin+Vout→+Vout. When the switching element Q3 is turned off and the switching element Q4 is turned on, the secondary side voltage V_CD of the transformer Tr changes from zero to a positive output voltage Vout, and the primary side voltage V_AB of the transformer Tr changes from zero to a positive input voltage Vin. Therefore, the change amplitude of the voltage V_Lr on the high-frequency inductor Lr is zero→Vin−Vout. When the switching element Q1 is turned off and the switching element Q2 is turned on, the secondary side voltage V_CD of the transformer Tr is the positive output voltage Vout, and the primary side voltage V_AB of the transformer Tr changes from the positive input voltage Vin to zero. Therefore, the change amplitude of the voltage V_Lr on the high-frequency inductor Lr is Vin−Vout→−Vout. When the switching element Q4 is turned off and the switching element Q3 is turned on, the secondary side voltage V_CD of the transformer Tr changes from zero to the negative output voltage Vout, and the primary side voltage V_AB of the transformer Tr changes from zero to the negative input voltage Vin. Therefore, the change amplitude of the voltage V_Lr on the high-frequency inductor Lr is zero→−Vin+Vout. When the switching element Q6 is turned off and the switching element Q5 is turned on, the secondary side voltage V_CD of the transformer Tr changes from the negative output voltage Vout to zero, and the primary side voltage V_AB of the transformer Tr is zero. Therefore, the change amplitude of the voltage V_Lr on the high-frequency inductor Lr is +Vout→zero. When the switching element Q8 is turned off and the switching element Q7 is turned on, the secondary side voltage V_CD of the transformer Tr changes from zero to the positive output voltage Vout, and the primary side voltage V_AB of the transformer Tr changes from zero to the positive input voltage Vin. Therefore, the change amplitude of the voltage V_Lr on the high-frequency inductor Lr is zero-Vin-Vout. When the switching element Q5 is turned off and the switching element Q6 is turned on, the secondary side voltage V_CD of the transformer Tr changes from the positive output voltage Vout to zero, and the primary side voltage V_AB of the transformer Tr is zero. Therefore, the change amplitude of the voltage V_Lr on the high-frequency inductor Lr is −Vout→zero. When the switching element Q7 is turned off and the switching element Q8 is turned on, the secondary side voltage V_CD of the transformer Tr changes from zero to the negative output voltage Vout, and the primary side voltage V_AB of the transformer Tr changes from zero to the negative input voltage Vin. Therefore, the changed amplitude of the voltage V_Lr on the high-frequency inductor Lr is zero→−Vin+Vout.

In the case of a boost mode, the boost mode can be viewed as similar to the buck mode but from the output to the input, so the explanation is omitted.

As described above, in the DAB converter 100, the change of current direction of any bridge arm will lead to a change in the voltage V_AX, that is, the voltage of the high-frequency inductor Lr will change. In example embodiments, when a switching element of a bridge arm is turned off, it is possible to determine a timing of turning on another switching element of the same bridge arm by detecting a plateau voltage of the high-frequency inductor Lr, a rising edge or falling edge of the voltage, and a change of the voltage itself. According to the detection result of the detecting the voltage of the high-frequency inductor Lr, the dead time may be set, and/or a turn-on control signal may be transmitted to the other switching element of the same bridge arm.

In example embodiments, the dead time can be set when the rising edge or the falling edge of the voltage of the high-frequency inductor Lr is detected. Based on this, it is easy to identify the change of the voltage of the high-frequency inductor Lr, and easy to set the dead time.

Next, a specific example of setting the dead time is illustrated.

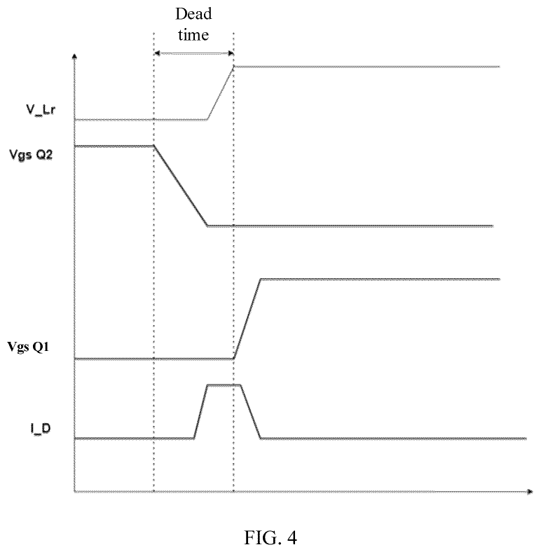

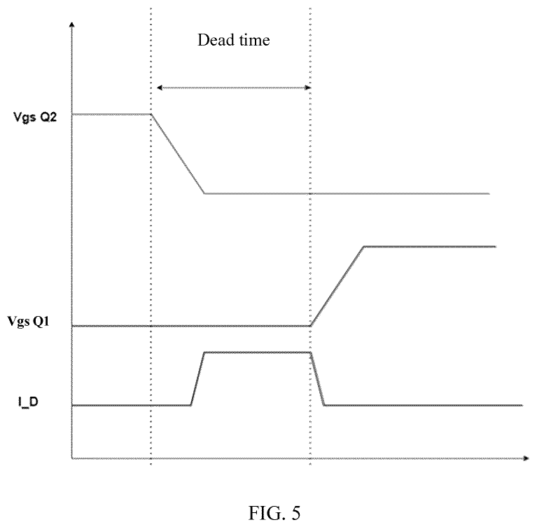

FIG. 4 is a schematic waveform diagram for illustrating an effect of setting a dead time in a method of controlling a dual active bridge converter according to example embodiments of the present disclosure. FIG. 5 is a schematic waveform diagram for illustrating an effect of setting a dead time in a method of controlling a dual active bridge converter in a comparative example.

In FIG. 4, an example of setting the dead time in the method of controlling a dual active bridge converter 100 in example embodiments is shown, in which the switching element Q2 is turned off and the switching element Q1 is turned on. As shown in FIG. 4, Vgs Q1 represents a control signal used to control the switching element Q1 to turn on or turn off, Vgs Q2 represents a control signal used to control the switching element Q2 to turn on or turn off, V_Lr represents the voltage of the high-frequency inductor Lr, and I_D represents the current flowing through the body diode of the switching element Q1.

As shown in FIG. 4, when the switching element Q2 is turned off and the switching element Q1 is about to be turned on, in response to a rising edge of the voltage of the high-frequency inductor Lr being detected, a time difference between a time instant at which the switching element Q2 is turned off and a time instant at which the rising edge is detected is calculated, and the time difference is set as the dead time. Based on this, it is possible to further set the dead time to be within an appropriate range.

In FIG. 5, a comparative example is shown where the dead time is set to a fixed value, the switching element Q2 is turned off, and the switching element Q1 is turned on. Similarly, as shown in FIG. 5, Vgs Q1 represents a control signal used to control the switching element Q1 to turn on or turn off, Vgs Q2 represents a control signal used to control the switching element Q2 to turn on or turn off, and I_D represents the current flowing through the body diode of the switching element Q1.

As shown in FIGS. 4 and 5, compared with setting the dead time to a fixed value in the related art, example embodiments of the present disclosure may achieve a reduction in the dead time, thereby reducing the time length for the current to flow through the body diode of the switching element, which may reduce power consumption, and improve converter efficiency.

In example embodiments of the present disclosure, when setting the dead time according to the detection result of the detecting the voltage of the high-frequency inductor Lr, the time difference between the time instant at which the switching element is turned off and the time instant at which the rising edge or falling edge is detected can be calculated when the rising edge or falling edge of the voltage of the high-frequency inductor Lr is detected, and the time difference is set as the dead time. Based on this, it is possible to further set the dead time to be within an appropriate range.

In addition, in example embodiments, according to the illustration with reference to FIG. 3, in a case that an operating mode of the DAB converter 100 is a buck mode, the voltage of the high-frequency inductor Lr can be detected when one of the switching elements included in the leading arm of the primary side full-bridge circuit is turned off. In a case that the operating mode of the DAB converter 100 is a boost mode, the voltage of the high-frequency inductor Lr can be detected when one of the switching elements included in the leading arm of the secondary side full-bridge circuit is turned off. In this way, it is possible to select the rising edge or falling edge with the maximum voltage change as a triggering condition, to calculate an appropriate dead time, thus adjusting the dead time with higher accuracy.

In addition, in example embodiments, when setting the dead time according to the detection result of the detecting the voltage of the high-frequency inductor Lr, whether the calculated time difference between the time instant at which the switching element is turned off and the time instant at which the rising edge or falling edge is detected is less than a default dead time can be determined. If the time difference is less than the default dead time, the time difference is set as the dead time. Based on this, it is possible to prevent situations where the dead time is incorrectly set due to detection errors or calculation errors.

In example embodiments, after setting the dead time by switching the conduction of switching elements of a bridge arm, it is also possible to apply such dead time to other bridge arms within one cycle or in a subsequent operation. It is also possible to reset the dead time every time the conduction of the switching elements of the bridge arm is switched. It is also possible to set one dead time within each operating cycle by switching the conduction of the switching elements of the bridge arm.

It should be noted that in example embodiments, after setting the dead time according to a bridge arm of a full-bridge circuit, a switching element of another bridge arm of the full-bridge circuit can be turned on after the dead time, after another switching element of the other bridge arm is turned off. In addition, in example embodiments, after setting the dead time according to a bridge arm of a full-bridge circuit, a switching element of a bridge arm of another full-bridge circuit can be turned on after the dead time, after another switching element of the bridge arm of the other full-bridge circuit is turned off.

It should be noted that, according to example embodiments, for the bridge arm, in a process of turning off a switching element to turning on another switching element, compared to the usual passive waiting for a fixed dead time, the present disclosure may detect the voltage signal on the high-frequency inductor Lr after a switching element is turned off, and when a voltage change is detected on the high-frequency inductor Lr, another switching element may be actively turned on.

According to example embodiments, the dead time may be automatically set. By using the sampling circuit to detect the voltage signal on the high-frequency inductor Lr, it is possible to set the most appropriate time instant to turn on the MOS transistor, and the dead time may be set to be within an appropriate range.

According to example embodiments of the present disclosure, an apparatus of controlling a dual active bridge converter is further provided. The dual active bridge converter includes a first full-bridge circuit and a high-frequency inductor, the first full-bridge circuit includes a first bridge arm, the first bridge arm includes a first switching element and a second switching element connected in series, and the apparatus includes a module used to detect a voltage of the high-frequency inductor in response to the first switching element being turned off; a module used to set a dead time according to a detection result of the detecting the voltage of the high-frequency inductor; and a module used to turn on the second switching element based on the dead time.

According to example embodiments of the present disclosure, an electronic device, a non-transitory or non-volatile computer-readable storage medium, and a computer program product are further provided.

The electronic device may be a digital signal processor (DSP) or a microcontroller (MCU), etc. Those skilled in the art should understand that the various functions and/or operations and steps disclosed in the present disclosure may be individually and/or jointly implemented through various hardware, software, firmware, or substantially any combination thereof. In an example embodiment, several elements, portions, features, functions, characteristics, etc., of example embodiments of the present disclosure may be implemented through application specific integrated circuit (ASIC), field programmable gate array (FPGA), digital signal processor (DSP), microcontroller unit (MCU), or other integrated formats. Moreover, those skilled in the art should recognize that some aspects of the disclosed example embodiments may be globally or partially equivalently implemented in an integrated circuit, implemented as one or more computer programs running on one or more computers (e.g., implemented as one or more programs running on one or more computer systems), implemented as one or more programs running on one or more processors (e.g., implemented as one or more programs running on one or more microprocessors), implemented as firmware, or substantially implemented as any combination of the above, and those skilled in the art will have the ability to design circuits and/or write software and/or firmware code in accordance with the present disclosure. In addition, those skilled in the art will recognize that the mechanism of the subject matter disclosed herein may be distributed as various forms of program products, and example embodiments of the subject matter disclosed herein are applicable regardless of the specific type of signal carrier medium actually used to perform the distribution. Examples of the signal carrying medium include but are not limited to: recordable medium, such as floppy disks, hard drives, compact discs (CDs), digital versatile discs (DVDs), digital magnetic tapes, computer memory, etc.; and transmission medium, such as digital and/or analog communication medium (such as fiber optic cables, waveguides, wired communication links, wireless communication links, etc.).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of controlling a dual active bridge converter including a first full-bridge circuit and a high-frequency inductor, the first full-bridge circuit includes a first bridge arm including a first switching element and a second switching element connected in series, the method comprising:
detecting a voltage of the high-frequency inductor in response to the first switching element being turned off;
setting a dead time according to a detection result of the detecting the voltage of the high-frequency inductor; and
turning on the second switching element based on the dead time.

2. The method according to claim 1, wherein the detecting the voltage of the high-frequency inductor includes:
detecting, by using a sampling circuit including an inductor coupled with the high-frequency inductor, an induced voltage generated on the inductor as the voltage of the high-frequency inductor.

3. The method according to claim 1, wherein the setting the dead time according to the detection result of the detecting the voltage of the high-frequency inductor includes:
setting the dead time in response to a rising edge or a falling edge of the voltage of the high-frequency inductor being detected.

4. The method according to claim 1, wherein the setting the dead time according to the detection result of the detecting the voltage of the high-frequency inductor includes:
calculating a time difference between a time instant at which the first switching element is turned off and a time instant at which a rising edge or a falling edge of the voltage of the high-frequency inductor is detected in response to the rising edge or the falling edge of the voltage of the high-frequency inductor being detected, and determining the time difference as the dead time.

5. The method according to claim 4, wherein the setting the dead time according to the detection result of the detecting the voltage of the high-frequency inductor further includes:
determining whether the time difference is less than a default dead time; and
setting the time difference as the dead time in a case that the time difference is less than the default dead time.

6. The method according to claim 1, further comprising:
transmitting a turn-on control signal to the second switching element according to the detection result of the detecting the voltage of the high-frequency inductor.

7. The method according to claim 1, wherein the first full-bridge circuit further includes a second bridge arm connected in parallel with the first bridge e arm, and the method further comprises:
turning on a switching element of the second bridge arm after the dead time, after another switching element of the second bridge arm is turned off.

8. The method according to claim 1, wherein the dual active bridge converter further includes a second full-bridge circuit, and the method further comprises:
turning on a switching element of a bridge arm of the second full-bridge circuit after the dead time, after another switching element of the bridge arm of the second full-bridge circuit is turned off.

9. The method according to claim 1, wherein
in a case that an operating mode of the dual active bridge converter is a buck mode, the first full-bridge circuit includes a primary side full-bridge circuit, and the first bridge arm includes a leading arm; and
in a case that the operating mode of the dual active bridge converter is a boost mode, the first full-bridge circuit includes a secondary side full-bridge circuit, and the first bridge arm includes a leading arm.

10. The method according to claim 2, wherein the setting the dead time according to the detection result of the detecting the voltage of the high-frequency inductor includes:
setting the dead time in response to a rising edge or a falling edge of the voltage of the high-frequency inductor being detected.

11. The method according to claim 2, wherein the setting the dead time according to the detection result of the detecting the voltage of the high-frequency inductor includes:
calculating a time difference between a time instant at which the first switching element is turned off and a time instant at which a rising edge or a falling edge of the voltage of the high-frequency inductor is detected in response to the rising edge or the falling edge of the voltage of the high-frequency inductor being detected, and determining the time difference as the dead time.

12. The method according to claim 2, further comprising:
transmitting a turn-on control signal to the second switching element according to the detection result of the detecting the voltage of the high-frequency inductor.

13. The method according to claim 2, wherein the first full-bridge circuit further includes a second bridge arm connected in parallel with the first bridge arm, and the method further includes:
turning on a switching element of the second bridge arm after the dead time, after another switching element of the second bridge arm is turned off.

14. The method according to claim 2, wherein the dual active bridge converter further includes a second full-bridge circuit, and the method further includes:
turning on a switching element of a bridge arm of the second full-bridge circuit after the dead time, after another switching element of the bridge arm of the second full-bridge circuit is turned off.

15. A dual active bridge converter comprising:
a first full-bridge circuit;
a second full-bridge circuit;
a high-frequency transformer;
a high-frequency inductor; and
a sampling circuit; wherein
the sampling circuit includes an inductor coupled with the high-frequency inductor, and the inductor is configured to couple with the high-frequency inductor to generate an induced voltage.

16. The dual active bridge converter according to claim 15, wherein the sampling circuit further includes a resistor connected in parallel with the inductor.

17. An apparatus to control a dual active bridge converter including a first full-bridge circuit and a high-frequency inductor, the first full-bridge circuit including a first bridge arm that includes a first switching element and a second switching element connected in series, the apparatus comprising:
a detector to detect a voltage of the high-frequency inductor in response to the first switching element being turned off;
a setter to set a dead time according to a detection result of the detecting the voltage of the high-frequency inductor; and
a controller configured or programmed to turn on the second switching element based on the dead time.

18. An electronic device comprising:
at least one processor; and
a memory communicatively connected to the at least one processor; wherein
the memory stores instructions executable by the at least one processor, and the instructions, when executed by the at least one processor, are configured to cause the at least one processor to perform the method of claim 1.

19. A non-transitory computer-readable storage medium including computer instructions therein, wherein the computer instructions are configured to cause a computer to perform the method of claim 1.
